(19) United States
(12) Patent Application Publication
(10) Pub. No.: US 2026/0238349 A1
(43) Pub. Date: Aug. 13, 2026

(54) OPTICAL INTERCONNECT SYSTEM WITH OPTICAL PILOT ASSISTED RECEPTION

(71) Applicant: Indian Institute of Technology Bombay, Mumbai (IN)

(72) Inventors: Shalabh Gupta, MUMBAI (IN); Aboobackkar Sidhique, MUMBAI (IN); Surya Karmakar, MUMBAI (IN)

(21) Appl. No.: 19/535,539

(22) Filed: Feb. 10, 2026

(30) Foreign Application Priority Data
Feb. 10, 2025 (IN) 202521011259

(51) Int. Cl. H04B 10/532

(52) U.S. Cl. CPC H04B 10/532

(57) ABSTRACT

The present invention discloses an optical interconnect system (100) with an optical pilot-assisted reception receiver (130). The system (100) includes at least one transmitter (110) including at least one multi-wavelength laser source (111) configured to emit light with a plurality of wavelengths, at least one optical modulator block (112) connected to the multi-wavelength laser source (111), where the optical modulator block (112) is configured to split the received carriers into two polarization channels corresponding to light in the two orthogonal polarization components, and at least one polarization multiplexer (P-Mux) (113) connected to the optical modulator block (112), where the P-Mux (113) combines at least one independent modulated signal and at least one optical pilot at different wavelengths from the two polarization channels into a polarization-multiplexed signal, and at least one optical channel (120) to transmit the polarization-multiplexed signal from the transmitter (110) to the receiver (130).

### FIELD OF THE INVENTION

The application is based on and claims priority from Indian Application 202521011259 filed on 10 Feb. 2025, the disclosure of which is hereby incorporated by reference herein. The present invention pertains to the field of optical communication. More specifically, the invention relates to an optical interconnect system incorporating optical pilot assisted reception and the method for implementing the same.

### BACKGROUND

In recent years, there has been an explosive growth in both the creation and use of data, largely propelled by advancements in technologies such as Generative Artificial Intelligence (Gen AI), Cloud Computing, and Virtual Reality (VR). This surge has triggered intense competition to enhance bandwidth capabilities, which are crucial for managing the ever-increasing data volumes. However, this pursuit is not without its challenges, notably the inevitable trade-off of heightened power consumption. Projections suggest that by 2030, data centers could account for as much as 8% of global energy usage, underscoring the urgent necessity for energy-efficient data centers to avert a looming energy crisis. The primary energy consumers in data centers include interconnects, servers, cooling systems, and memories, with interconnects alone responsible for around 27% of total energy consumption.

In existing mechanisms for short-reach optical interconnects employed in data centers and campus networks, single-polarization intensity modulation and direct detection (IM-DD) links have been the preferred choice due to their simplicity and cost-effective implementation. Presently, to meet the demands for higher capacity, four-level pulse amplitude modulation (4-PAM) based IM-DD links are employed. Yet, challenges persist such as noise limitations and the inherent nonlinearity of electronic and optoelectronic components, which hinder further capacity expansion by incorporating additional amplitude levels. Another approach to enhance capacity involves increasing the baud rate, but this is constrained by chromatic dispersion, which imposes limits on communication distance due to dispersion-induced frequency nulls at higher frequency components.

One widely adopted technique to boost overall capacity is wavelength division multiplexing (WDM), wherein multiple wavelength channels are utilized for data transmission and reception. However, this method is also limited by chromatic dispersion affecting the maximum achievable transmission distance. An additional or alternative strategy for increasing data rates involves leveraging both orthogonal polarization modes to convey information. This approach is known as dual-polarization (DP) signaling. Nonetheless, signals transmitted through the channel are susceptible to various polarization impairments, necessitating an adaptive polarization demultiplexer (APD) at the receiver. Although APD can be and has been achieved with the use of digital signal processing (DSP), it comes with substantial additional power consumption and cost overheads.

To enhance link capacity and increase the distance of transmission, coherent modulation and demodulation-based links are used. The link distances in coherent links are not constrained by chromatic dispersion and are well-suited for long-distance communication. Additionally, coherent links support multi-dimensional modulation formats with better receiver sensitivity. Coherent links can also use both the orthogonal polarizations as separate channels to further increase the capacity. The coherent links that use polarization multiplexing to achieve two independent channels for transmission are known as dual-polarization (DP) coherent links. However, coherent links also pose their own sets of challenges. Impairments such as polarization mode dispersion and transmit & receiver side (LO—local oscillator) laser frequency mismatches and phase noise can adversely impact the quality of received signals in coherent links. To address these issues, coherent links employ DSP-based polarization demultiplexing, equalization, carrier frequency and phase recovery, and clock recovery. Additionally, forward error correction (FEC) techniques are used, as has been done in IM-DD links. These DSP operations along with high-speed ADCs contribute to significant energy consumption, particularly in short-reach communication links. Although there are proposals aimed at reducing the energy consumption of DSP-based short-reach coherent links, further exploration in this direction is necessary. Thus, it is desired to address the above-mentioned disadvantages or other shortcomings, or at least provide a useful alternative.

The principal object of the invention herein is to provide an optical interconnect system with optical pilot-assisted reception and an implementation method thereof. Another object of the invention herein is to provide a multi-wavelength dual-polarization coherent interconnect with the proposed optical pilot-assisted adaptive polarization demultiplexing (OP-APD) and the optical pilot-assisted adaptive polarization demultiplexing and clock recovery (OP-APD-CR) techniques. Yet another object of the invention herein is to provide a polarization multiplexed carrier-based self-homodyne (PMC-SH) coherent link with the proposed OP-APD and the OP-APD-CR techniques. Yet another object of the invention herein is to provide an intensity modulation and direct detection (IM-DD) link with the proposed OP-APD and the OP-APD-CR techniques. Yet another object of the invention herein is to provide a co-packaged optics-based IM-DD interconnect with the proposed OP-APD and the OP-APD-CR techniques.

### SUMMARY

In an aspect, the objectives are achieved by providing an optical interconnect system with optical pilot-assisted reception at a receiver. The optical interconnect system includes at least one transmitter, at least one optical channel, and at least one receiver. The transmitter includes at least one multi-wavelength laser source configured to emit light with a plurality of wavelengths comprising at least one optical pilot and a plurality of wavelength carriers. Additionally, the transmitter includes at least one optical modulator block connected to the multi-wavelength laser source. The optical modulator block is configured to split the received carriers into two polarization channels corresponding to light in the two orthogonal polarization components. At least one of the carrier components in each of the channels is modulated independently with the input electrical signals using electro-optic modulators. Furthermore, the transmitter includes at least one polarization multiplexer (P-Mux) connected to the optical modulator block. The P-Mux combines at least one independent modulated signal and at least one optical pilot at different wavelengths from the two polarization channels into a polarization-multiplexed signal.

The at least one optical channel connects the transmitter to the receiver and transmits the polarization-multiplexed signal from the transmitter to the receiver.

The system further includes at least one receiver connected to the optical channel. The receiver comprises at least one polarization demultiplexer (P-Demux) connected to the optical channel. The P-Demux adjusts the polarization of the polarization-multiplexed signal by splitting a modulated signal in the first polarization channel and a the optical pilot in the second polarization channel along with optionally other modulated signals or unmodulated carrier. Additionally, the receiver includes at least one optical demodulator block connected to the P-Demux. The optical demodulator block demultiplexes the first input polarization channel to a subset of wavelength channels using a wavelength demultiplexer and demultiplexes the second input polarization channel to a subset of wavelength channels using a wavelength demultiplexer. At least one monitor and control unit is connected to the optical demodulator block and the P-Demux. The monitor and control unit taps into at least one of the polarization components of the optical pilot wavelength channel and generates control signals to the P-Demux. Finally, the receiver includes at least one electronic signal processing unit connected to the optical demodulator block. The electronic signal processing unit receives electrical signals after demodulating at least one of the modulated optical signals in one of the wavelength channels, where the received electrical signals are used for processing of the electrical signals.

### BRIEF DESCRIPTION OF FIGURES

These and other features, aspects, and advantages of the present invention are illustrated in the accompanying drawings, throughout which like reference letters indicate corresponding parts in the various figures. The embodiments herein will be better understood from the following description with reference to the drawings, in which:

FIG. 1 is a block diagram that illustrates a proposed optical interconnect system with optical pilot-assisted reception at a receiver according to embodiments as disclosed herein.

FIG. 2 is a flow diagram that illustrates a proposed method for optical pilot-assisted reception at a receiver according to embodiments as disclosed herein.

FIG. 3A is a block diagram that illustrates a multi-wavelength dual-polarization coherent interconnect with the OP-APD technique according to embodiments as disclosed herein.

FIG. 3B is a block diagram that illustrates a multi-wavelength dual-polarization coherent interconnect with the OP-APD-CR technique according to embodiments as disclosed herein.

FIG. 4A is a block diagram that illustrates a multi-wavelength PMC-SH interconnect with the OP-APD technique according to embodiments as disclosed herein.

FIG. 4B is a block diagram that illustrates a multi-wavelength PMC-SH interconnect with the OP-APD-CR technique according to embodiments as disclosed herein.

FIG. 5A is a block diagram that illustrates a multi-wavelength IM-DD interconnect with the OP-APD technique according to embodiments as disclosed herein.

FIG. 5B is a block diagram that illustrates a multi-wavelength IM-DD interconnect with the OP-APD-CR technique according to embodiments as disclosed herein.

FIG. 6A is a block diagram that illustrates a multi-wavelength co-packaged optics-based IM-DD interconnect with the OP-APD technique according to embodiments as disclosed herein, and

FIG. 6B is a block diagram that illustrates a multi-wavelength co-packaged optics-based IM-DD interconnect with the OP-APD-CR technique according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is existing in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Various power-efficient approaches to relax the receiver-side ADC and DSP requirements are proposed in the existing mechanism. One such approach involves multiplexing the carrier and the modulated signals in orthogonal polarization, a technique known as polarization multiplexed carrier-based self-homodyne (PMC-SH) coherent link. In this configuration, the carrier effectively serves as the optical pilot, aiding polarization demultiplexing. Both the carrier and the modulated signal undergo the same frequency drift and phase noise, eliminating the necessity for carrier frequency and phase recovery and compensation. This design also allows for the utilization of low-cost uncooled distributed-feedback (DFB) laser sources.

However, an efficient method of polarization demultiplexing is needed in the PMC-SH link to ensure accurate signal reception, which is a prerequisite before any further demodulation and signal processing are performed. A straightforward and cost-effective polarization demultiplexing method addresses this challenge, thereby reducing the DSP complexity. The PMC-SH link offers a good solution aimed at reducing power consumption and cost while achieving higher capacity in the optical link. However, it effectively halves the available channels compared to DP coherent links, as one polarization channel is dedicated to transmitting the carrier. To increase overall capacity, the use of WDM techniques becomes necessary, introducing additional costs and complexity.

As data centers strive to meet escalating data-throughput requirements, traditional optical communication interconnect technologies face limitations in terms of energy efficiency and form factors for the desired data rates. Co-packaged optics (CPO) is emerging as a promising solution to address these constraints. Integrating photonic and electronic integrated circuits on a single package substrate helps reduce energy consumption and increase overall capacity. With progress in photonic integrated circuits, CPO also contributes to system compactness by replacing bulky components. However, the implementation of CPO comes with its own set of challenges and limitations. Integrating diverse technologies within a single package requires careful consideration to ensure reliable operation. The manufacturing process for CPO is often more complex compared to traditional approaches, demanding advanced manufacturing techniques to achieve the precision required for optical components alongside electronic counterparts.

Currently, CPO-based interconnects primarily employ single-polarization IM-DD links due to their straightforward implementation and integration. The capacity of CPO-based interconnects can be doubled by multiplexing message signals in orthogonal polarization channels. As discussed earlier, the continuous polarization changes experienced by signals in optical channels necessitate an effective APD technique for recovering the original messages. DSP-based APD has been widely used, but its high energy consumption necessitates the development of energy-efficient APD methods. Existing mechanisms describe some energy-efficient APD techniques that utilize electrical marker tones to separate dual-polarization signals. However, such methods may encounter challenges such as limiting the polarization tracking speed and impacting the practicality of these approaches. In addition to polarization-related issues, clock recovery poses a significant concern during signal reception in optical communication links. Conventionally, DSP-based clock recovery methods are used. However, to achieve energy-efficient DSP-lite or DSP-free reception, the adoption of analog domain clock recovery with the clock being forwarded from the transmitter side can become useful.

Embodiments disclosed herein provide an optical interconnect system with optical pilot-assisted reception and an implementation method thereof. The solution proposes an innovative approach to achieve OP-APD. This method is designed to properly separate independent orthogonal polarization components within a dual-polarization optical signal in an optical communication link. The optical pilot-based approach also incorporates the flexibility of modulating the optical pilot with the clock that is retrievable at the receiver, termed optical pilot-assisted clock recovery (OP-CR). The OP-CR alleviates the need for energy-intensive DSP-based clock recovery, which can be performed independently when a clock-modulated optical pilot is transmitted alongside modulated signals. The optical pilot-assisted polarization demultiplexing and clock recovery techniques can be combined, and this integrated method is termed OP-APD-CR. This proposed method is versatile, demonstrating independence from modulation methods and applicability to various formats such as PAM-N, QAM-N, PSK-N, and others.

In an embodiment, the OP-APD, OP-CR, and OP-APD-CR are versatile approaches that can be applied to various optical communication interconnects with different modulation formats. They are also suitable for co-packaged optics (CPO) solutions with multiple wavelength channels and are applicable to solutions employing pluggable or near-package optics with direct detection or coherent detection techniques.

In an embodiment, there are two principal orthogonal axes of polarization of linearly polarized light, termed the X or horizontal axis and the Y or vertical axis. Linearly polarized light can be present entirely along only one polarization axis or have non-zero amplitude components along both polarizations. When the linearly polarized light is present along the X axis only, it is called X polarized light. Similarly, if the linearly polarized light is present along the Y axis only, it is called Y polarized light. In the proposed solution, the light wave launched into the fiber at the transmitter output is wavelength division multiplexed (WDM) with the first set of independent modulated optical signals. The multiplexed signal is fed into the first input port of a polarization multiplexer. The second set of independent modulated signals and/or independent carriers are fed into the second input of the polarization multiplexer to generate the polarization multiplexed signal at the multiplexer output, which is launched into the optical fiber. Therefore, the optical pilot is present only in one of the orthogonal polarizations at the output of the transmitter. The other orthogonal polarization is used to send another set of optical signals, which do not have the optical pilot at the output of the transmitter. During transmission in the fiber, both the optical pilot and the independent modulated signals encounter polarization impairments, leading to their scrambling across the orthogonal polarizations. Consequently, the optical pilot signal originally aligned in one of the orthogonal polarizations becomes altered. The polarization scrambling or rotation faced by the optical pilot and independent modulated signals are almost the same, provided that the wavelength of all the optical signals is close to each other and the polarization-dependent gain or loss in the optical channel is not significant.

In an embodiment, compensating for polarization impairment is essential for accurately retrieving the original information from the received optical signal without significant degradation in signal quality due to crosstalk. The optical pilot plays a crucial role in this process. By adjusting the polarization of the received signal, it is possible to maximize the concentration of power and information from the optical pilot in one polarization while minimizing it in the other. Since both the optical pilot and all the independent modulated (or carrier) signals undergo the same polarization changes, aligning the optical pilot to one of the polarization axes will result in the alignment of all the independent modulated (or carrier) signals with their respective orthogonal polarizations. This alignment enables the separation of the independent components of the multiplexed optical signals and aids in simplifying the recovery of the originally transmitted data. In an embodiment, this alignment process involves measuring the optical pilot power using monitor photodetectors (MPDs) in either one or both polarizations and employing control signals to manipulate a polarization controller. The control signals are given such that either the power in one orthogonal polarization is maximized/minimized or the difference in optical power in both orthogonal polarizations is maximized. This essentially results in polarization demultiplexing.

In an embodiment, the solution proposes optical pilot-assisted reception techniques for optical interconnects that utilize orthogonal polarizations in the optical fiber for multiplexing independent modulated optical signals and at least one optical pilot. The proposed techniques achieve optical pilot-assisted adaptive polarization demultiplexing and/or optical pilot-assisted clock recovery.

In optical pilot-assisted adaptive polarization demultiplexing (OP-APD), at least one optical pilot conveys information about the alignment of the independent orthogonal polarization components of the transmitted signal. The optical pilot is transmitted in one of the orthogonal polarizations alongside the dual-polarization wavelength division multiplexed (WDM) signals through an optical channel. At the receiver end, an adaptive polarization demultiplexing (APD) technique utilizing power minimization and/or maximization algorithms separates the independent orthogonal polarization components of the dual-polarization WDM signals. The OP-CR can also be performed independently when a clock-modulated optical pilot is transmitted alongside modulated signals.

The proposed pilot-assisted reception approach can also be used for jointly performing OP-APD-CR. The OP-APD-CR involves using at least one modulated optical pilot to convey the clock information along with the information about the alignment of the independent orthogonal polarization components of the transmitted signals. In the OP-APD-CR, the optical pilot is modulated with a clock signal and transmitted alongside other dual-polarization WDM signals through an optical channel. At the receiver end, adaptive polarization demultiplexing (APD) can use a power minimization and/or maximization algorithm to separate the independent orthogonal polarization components of the dual-polarized WDM signals. In addition, the optical pilot is demodulated to recover the data clock. The obtained clock is then utilized to assist data recovery.

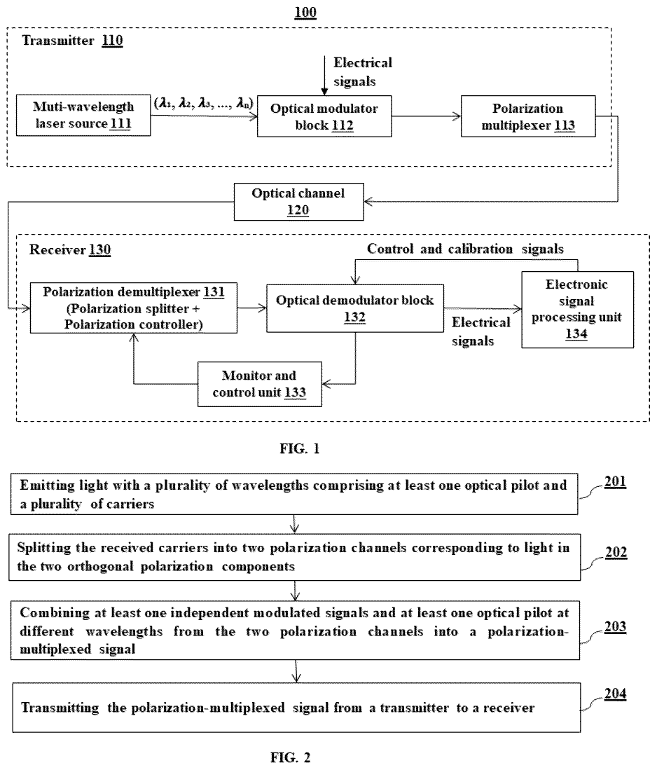

Referring now to the drawings, and more particularly to FIGS. 1 through 6, where similar reference characters denote corresponding features consistently throughout the figures, there are shown embodiments.

FIG. 1 is a block diagram illustrating a proposed optical interconnect system (100) with an optical pilot-assisted reception at a receiver (130) according to embodiments as disclosed herein. In the proposed system, the optical pilot can also be used for clock recovery at the receiver (130).

FIG. 1 illustrates an embodiment of the proposed OP-APD based multi-wavelength optical interconnect. The system comprises three parts, including a transmitter (110), an optical channel (120), and the receiver (130).

In an embodiment, the transmitter (110) comprises a few components depending on the chosen architecture. The essential elements include at least one multi-wavelength laser source (MWLS) (111), at least one optical modulator block (112), and at least one polarization multiplexer (P-Mux) (113) as depicted in FIG. 1. The multi-wavelength laser source (111), achieved through a laser bank or laser comb source, emits light with a plurality (spectrum of n) of wavelengths (λ₁, λ₂, λ₃, λₙ) comprising at least one optical pilot and a plurality of wavelength carriers. To accommodate diverse requirements, the MWLS (111) can launch light into individual waveguides for each wavelength or consolidate/generate multiple wavelengths as a wavelength comb and launch it into a single waveguide. It is essential to note that the wavelengths λ₁ to λₙ may not follow a monotonic sequence with respect to the wavelength indices 1 to n, and the spacings between adjacent wavelengths may not be the same. In the optical modulator block (112) connected to the multi-wavelength laser source (111), the multi-wavelength laser source (111) of wavelengths λ₂ to λₙ (carrier laser sources) are utilized as carriers that are modulated by input electrical signals. The multi-wavelength laser source (111) of wavelength λ₁ (pilot laser source) serves as the optical pilot conveying the polarization information of the transmitted signals. The optical pilot may also be modulated with the clock in the optical modulator block (112), thus carrying both the clock and the polarization information (clock-modulated optical pilot). The second polarization channel may also carry a modulated optical signal (or clock-modulated optical signal) to use the λ₁ channel more efficiently. The proposed transmitter (111) depicts the use of only one optical pilot (i.e., at wavelength λ₁). However, more than one pilot can be used to improve the polarization tracking capabilities. Also, in the case of PMC-SH links, each wavelength can use an optical pilot in one of the polarizations, which also serves as the carrier for signal demodulation at the receiver (130). The multi-wavelength laser source (111) may be configured to emit light with a plurality of wavelengths in different optical waveguides or in a single optical waveguide. The carriers or the optical pilots are modulated with a clock at the transmitter (110) to aid in clock recovery at the receiver (130), where the electronic signal processing unit (134) at the receiver (130) is configured to recover the clock from at least one of the clock-modulated carriers or the clock-modulated optical pilots. In an embodiment, the carriers of the multi-wavelength laser source (111) are In-phase and Quadrature-phase (IQ) modulated to get independent coherent modulated signals for the two orthogonal polarizations of each wavelength channel combined with the optical pilot polarization multiplexed and transmitted over the optical channel, and corresponding Local Oscillator (LO) signals are generated at the receiver using a multi-wavelength laser source for coherent demodulation of the coherent modulated signals after polarization demultiplexing.

In an embodiment, in the optical modulator block (112), one or more of the carrier laser sources (carriers) is/are split into two channels that correspond to light in the two orthogonal polarization components at the output of the transmitter (110). The carrier components in each of these channels are then modulated independently with the input electrical signals using optical modulators inside the optical modulator block (112). One or more of the optical carriers passed into the optical modulator block (112) may be chosen not to be modulated and be transmitted as it is (without modulation). Ring modulators may be used if all the wavelengths are present in a single waveguide to modulate different wavelength components by different electrical signals. Similarly, electro-optic modulators which can include, but not limited to, Mach-Zehnder modulators (MZMs) may be used if different wavelengths are present in separate waveguides. When the MZMs are used, their outputs need to be multiplexed into a single waveguide with a wavelength division multiplexer (WDM) along with one or more of the optical pilot and the unmodulated carrier laser sources. Each polarization channel can feature any combination of wavelengths. Neither is it necessary for both channels to have all the wavelengths, nor is any specific combination mandatory.

In an embodiment, the outputs of the optical modulator block (112) are directed into the P-Mux (113). The P-Mux (113) essentially combines independent modulated signals and one or more optical pilots at different wavelengths from the two polarization channels into a single dual-polarized optical signal representing independent linear orthogonal polarization components at different wavelengths. These orthogonal polarization components are aligned either along the X-axis or along the Y-axis when launched into the optical fiber from the transmitter (110). This combined dual-polarized optical signal, which essentially consists of modulated optical signals at different wavelengths, one or two polarization components for each wavelength, and modulated or unmodulated pilot, is now referred to as the combined optical signal. The combined optical signal is transmitted through the optical channel (120), which is typically, but not necessarily, an optical fiber.

In an embodiment, in a photonic integrated circuit (PIC) or a planar light wave circuit (PLC), the light wave propagates in different modes typically characterized as Transverse Electric (TE) or Transverse Magnetic (TM) modes. Typically, waveguides in the PICs or the PLCs are used for the purposes of propagation and multiplexing/demultiplexing of the aforementioned optical signals and pilot(s). The P-Mux (113) can be implemented as a polarization rotator combiner (PRC) in the PIC or the PLC to convert one of the TE mode signals into the TM mode or vice-versa. The resultant TE and TM signals are combined and launched into the optical channel (120) (i.e., an optical fiber) as the dual-polarized combined optical signal. Alternatively, 2-dimensional (2D) vertical grating couplers in the PIC or the PLC can be used to combine the inputs corresponding to the two orthogonal polarizations, and the combined optical signal can be launched into the optical channel (120). In systems employing discrete components, achieving a similar outcome is feasible through a polarization beam combiner (PBC), which combines X and Y polarized signals into a single dual-polarized optical signal suitable for transmission.

In an embodiment, the optical channel (120) is used for the transmission of the combined optical signal from the transmitter (110) to the receiver (130). The optical channel (120) can be an optical fiber or can be some other medium that allows the propagation of light. Free space through which light can propagate can also be considered an optical channel (120). During transmission through the optical channel (120), the combined optical signal experiences impairments such as time-dependent polarization rotation and polarization mode dispersion in addition to other impairments. Polarization rotation and polarization mode dispersion lead to scrambling of the states of polarization of the optical signal obtained at the input of the receiver (130). This scrambling leads to intermixing of different polarization components at the receiver (130), which makes it difficult to recover the originally transmitted signal. This problem underscores the importance of implementing polarization tracking mechanisms at the receiver (130), which can help in de-scrambling the states of polarization of the received signal and receive the desired signals as the two orthogonal polarization components in the receiver (130).

In an embodiment, the combined optical signal at the input of the receiver (130) is processed by a combination of components. The essential elements include a polarization demultiplexer (P-Demux) (131), a monitor and control unit (133), an optical demodulator (132), and an electronic signal processing unit (134) as depicted in FIG. 1. The combined optical signal at the input of the receiver (130) undergoes polarization manipulation within the P-Demux (131) block. This process effectively adjusts the polarization of the received signal, ensuring that each of the independent modulated signals and optical pilot(s) are concentrated within their corresponding polarization channels. At the output of the P-Demux (131), this polarization-corrected signal is separated into two individual waveguides, each corresponding to one polarization channel. The P-Demux (131) adjusts the polarization of the polarization-multiplexed signal and splits a modulated signal in the first polarization channel and the optical pilot in the second polarization channel along with optionally other modulated signals or unmodulated carrier. In the PIC or the PLC, polarization demultiplexing can be accomplished with a polarization splitter rotator (PSR) and a polarization controller (PC). The PSR effectively segregates the dual-polarized signal into the TE mode and the TM mode components. Typically, in the PSR, the TE mode signal is directed to one of the optical waveguide output ports, and the TM mode signal undergoes conversion to the TE mode and is directed to the other optical waveguide output port of the PSR. These two outputs of the PSR represent two orthogonal polarization components of the optical signal that were incident at the input of the PSR. The outputs of the PSR are fed into the PC to effectively descramble the polarization and achieve demultiplexing of independent orthogonal polarization components that were transmitted by the transmitter. Alternatively, in systems employing discrete components for the P-Demux (131), achieving a similar outcome is feasible through the PC and a polarization beam splitter (PBS). In this case, the combined optical signal is sent through a PC for the desired change in polarization. The output of the PC is fed into the PBS, which splits the dual-polarized signal into its X and Y polarization components to achieve demultiplexing. In both implementations, the PC effectively manipulates the polarization of the received signal to maximize the separation of each independent orthogonal polarization component that was transmitted by the transmitter using control signals from the monitor and control unit. The two output channels of the P-Demux (131) corresponding to the two independent polarization components coming from the transmitter (110) are fed into an optical demodulator block (132).

In an embodiment, in the optical demodulator block (132), all the wavelength components are separated out into multiple wavelength sub-channels for each of its two input polarization channels. This can be achieved using a WDM filter or a ring resonator array for each of the two input polarization channels. The modulated optical signals in each sub-channel are demodulated into electrical signals in the optical demodulator block (132) and sent to an electronic signal processing unit (134), which is used for further processing of electrical signals. Additionally, if the optical pilot is clock modulated, the optical demodulator block (132) extracts the clock as an electrical output using a photodetector and forwards it to the electronic signal processing unit (134) for clock generation and data recovery. To monitor any of the optical pilot or the modulated signals, a certain amount of optical power is needed to be converted into electrical signals. This is accomplished using the MPDs, and it may also require splitting of the optical power using power splitters before the MPDs. The MPDs may be located in either the optical demodulator block (132) or the control and monitor unit. If the MPD is situated within the optical demodulator block (132), a fraction of optical power for the sub-channel to be monitored is converted to an electrical signal by the MPD and sent over to the monitor and control unit (133). Alternatively, if an MPD is present in the monitor and control unit (133), a fraction of optical power is split from the sub-channel intended to be monitored and routed into the monitor and control unit (133) as an optical signal. The optical signal is then converted to an electrical signal by the MPD within the monitor and control unit (133). The average power in the sub-channels containing the optical pilot or optical signal is sensed by the monitor and control unit (133) using the MPD output(s). In an embodiment, the optical demodulator block (132) demultiplexes the first input polarization channel to a subset of wavelength channels using a ring resonator array and demultiplexes the second input polarization channel to a subset of wavelength channels using the ring resonator array.

In an embodiment, the separation of each orthogonal polarization channel can be tracked by monitoring the average voltage, current, or power at one or more of the MPD outputs. Proper separation of independent modulated signals and the optical pilot(s) is achieved when the average power in one of the polarization channels is maximized and in the other channel it is minimized, i.e., the difference in average optical power in the two polarization channels is maximum. In this case, the polarization channel with maximum power contains the optical pilot(s), and the channel with minimum power contains one or more of the modulated optical signals or clock-modulated optical signals.

In an embodiment, alternatively, separation of independent modulated signals and the optical pilot(s) is achieved when the average power of optical pilot(s) in one or more wavelengths in one of the polarization channels is maximized and that in the other channel is minimized, i.e., the difference in average optical power in the two polarization channels is maximized.

The monitor and control unit (133) plays a crucial role in providing control signals to the P-Demux (131), ensuring proper separation of independent orthogonal polarization components of the combined optical signal at the output of the P-Demux (131). The control signals given to the P-Demux (131) are adjusted so as to maximize the average optical power in one of the polarization channels and minimize it in the other polarization channel so as to achieve maximum optical power difference between the two polarization channels, resulting in separation of the optical pilot(s) and the modulated optical signals that were transmitted by the transmitter (110) in the two orthogonal polarizations. These control signals effectively manipulate the polarization of the combined received signal, facilitating polarization demultiplexing at the output of the P-Demux (131). Consequently, each independent modulated signal and the optical pilot is concentrated exclusively within a single polarization channel. The two polarization channel outputs are forwarded to the optical demodulator block (132). The wavelength sub-channels for each polarization component are separated out using the WDM filters or ring resonators in the optical demodulator block (132). The independent modulated optical signals and clock-modulated optical signals or optical pilots used as optical carriers in the case of coherent links (as applicable) from each wavelength sub-channel for the two polarization channels are used in the optical demodulator block (132) to obtain the demodulated electrical signals and then forwarded to the electronic signal processing unit (134).

In an embodiment, the control signals given by the monitor and control unit (133) to the polarization demultiplexer (131) are adjusted to maximize the average optical power of the optical pilot in one of the polarization channels or minimize it in the other polarization channel or maximize the difference in average optical powers between the two orthogonal polarization channels using the monitor and control unit (133) for separation of independent modulated optical signals in the two orthogonal polarizations. Further, the control signals given by the monitor and control unit (133) to the polarization demultiplexer (131) are adjusted to maximize the average optical power of all the optical signals in one of the polarization channels or minimize the average optical power of all the optical signals in the other polarization channel or maximize the difference in average optical powers between the two orthogonal polarization channels using the monitor and control unit (133) for separation of the modulated optical signals in the two orthogonal polarizations.

In one embodiment, the multi-wavelength carriers are IQ modulated to get coherent modulated signals, and corresponding carriers are transmitted in the orthogonal polarization that are used as LO for coherent demodulation of the coherent modulated signal after polarization demultiplexing.

In another embodiment, the multi-wavelength carriers are intensity modulated at the transmitter (110) to obtain intensity modulated signals, combined with the optical pilot present as an independent wavelength in one of the polarization channels, polarization multiplexed, and then transmitted and polarization demultiplexed at the receiver (130) assisted by the optical pilot before being demodulated using photodetectors. Here, the multi-wavelength carriers are intensity modulated at the transmitter (110) to obtain intensity modulated signals using a ring modulator array, combined with an optical pilot present as an independent wavelength channel that is present in one of the polarization channels and suppressed in the other polarization channel, polarization multiplexed, transmitted through the optical channel (120), after which they are polarization demultiplexed at the receiver (130) assisted by the optical pilot, followed by wavelength demultiplexing using ring resonators and final demodulation using the photodetectors.

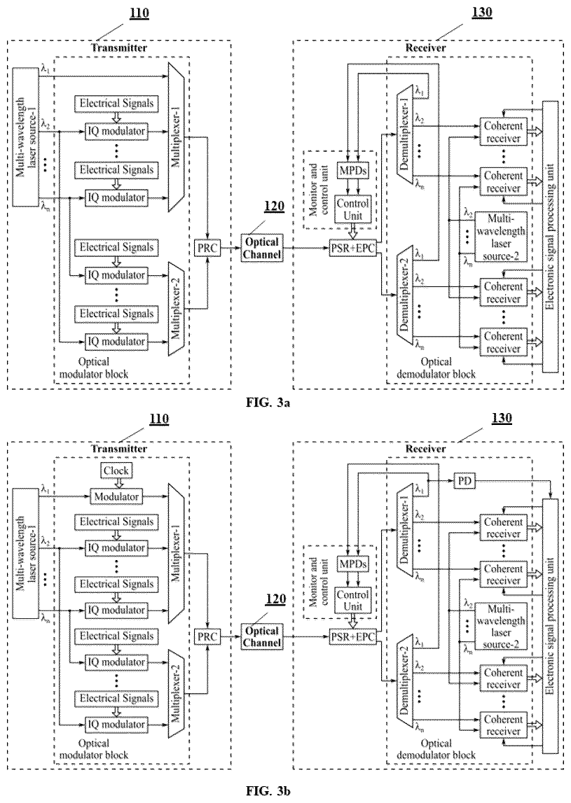

FIG. 2 is a flow diagram that illustrates a proposed method for optical pilot-assisted reception at the receiver (130) according to embodiments as disclosed herein. At step 201, the method includes emitting by an optical interconnect system (100) light with a plurality of wavelengths comprising at least one optical pilot and a plurality of carriers. The multiwavelength laser source (110) may emit light with a plurality of wavelengths in different optical waveguides or in a single optical waveguide. At step 20₂, the method includes splitting by the optical interconnect system (100) the received carriers into two polarization channels corresponding to light in the two orthogonal polarization components and where at least one of the carrier components in each of the channels is modulated independently with the input electrical signals using electro-optic modulators. The at least one of the carriers or the optical pilots is modulated with a clock at the transmitter (110) to aid in clock recovery at the receiver (130) and where the electronic signal processing unit (134) at the receiver (130) is configured to recover the clock from at least one of the clock modulated carriers or the clock modulated optical pilots. The optical modulator block (112) comprises at least one of ring modulators and Mach-Zehnder modulators (MZMs) where the ring modulators are used when all the wavelengths are present in the single optical waveguide to modulate different wavelength components by different electrical signals and where the MZMs are used when different wavelengths are present in different or separate optical waveguides.

At step 203, the method includes combining by the optical interconnect system (100) at least one independent modulated signal and at least one optical pilot at different wavelengths from the two polarization channels into a polarization-multiplexed signal. At step 204, the method includes transmitting by the optical interconnect system (100) the polarization-multiplexed signal from the transmitter to the receiver (130). Further, the method includes adjusting by the optical interconnect system (100) the polarization of the polarization-multiplexed signal and splitting a modulated signal in the first polarization channel and the optical pilot in the second polarization channel along with optionally other modulated signals or unmodulated carrier and demultiplexing by the optical interconnect system (100) the first input polarization channel to a subset of wavelength channels using a wavelength demultiplexer and demultiplexing the second input polarization channel to a subset of wavelength channels using the wavelength demultiplexer. The polarization-corrected signal at the P-Demux is separated into two individual waveguides each corresponding to one polarization channel. The polarization demultiplexer comprises at least one combination of a polarization splitter rotator (PSR) and a polarization controller (PC) or the PC and a polarization beam splitter (PBS).

Furthermore, the method includes tapping by the optical interconnect system (100) at least one of the polarization components of the optical pilot wavelength channel into the monitor and control unit (133) and generating control signals to the P-Demux (131) using the control unit (133) and receiving by the optical interconnect system (100) electrical signals after demodulating at least one of the modulated optical signals in one of the wavelength channels where the received electrical signals are used for processing of the electrical signals. The optical demodulator block (132) demultiplexes the first input polarization channel to a subset of wavelength channels using a ring resonator array and demultiplexes the second input polarization channel to a subset of wavelength channels using a ring resonator array. The control signals given by the monitor and control unit (133) to the polarization demultiplexer are adjusted to maximize the average optical power of the optical pilot in one of the polarization channels or minimize it in the other polarization channel or maximize the difference in average optical powers between the two orthogonal polarization channels using the monitor and control unit (133) for separation of independent modulated optical signals in the two orthogonal polarizations. The control signals given by the monitor and control unit (133) to the polarization demultiplexer (131) are adjusted to maximize the average optical power of all the optical signals in one of the polarization channels or minimize the average optical power of all the optical signals in the other polarization channel or maximize the difference in average optical powers between the two orthogonal polarization channels using the monitor and control unit (133) for separation of the modulated optical signals in the two orthogonal polarizations. The wavelength carriers of the multi-wavelength laser source are In-phase and Quadrature-phase (IQ) modulated to get independent coherent modulated signals for the two orthogonal polarizations of each wavelength channel, combined with the optical pilot polarization multiplexed and transmitted over the optical channel and corresponding Local Oscillator (LO) signals are generated at the receiver using a multi-wavelength laser source for a coherent demodulation of the coherent modulated signals after polarization demultiplexing. The wavelength carriers are IQ modulated to get coherent modulated signals corresponding carriers are transmitted in the orthogonal polarization that are used as LO for coherent demodulation of the coherent modulated signal after polarization demultiplexing. The wavelength carriers are intensity modulated at the transmitter (110) to obtain intensity modulated signals, combined with an optical pilot present as an independent wavelength in one of the polarization channels, polarization multiplexed, and then transmitted and polarization demultiplexed at the receiver (130) assisted by the optical pilot before being demodulated using the photodetectors. The wavelength carriers are intensity modulated at the transmitter (110) to obtain intensity modulated signals using a ring modulator array, combined with an optical pilot present as an independent wavelength channel that is present in one of the polarization channels and suppressed in the other polarization channel, polarization multiplexed transmitted through the optical channel (120) after which they are polarization demultiplexed at the receiver (130) assisted by the optical pilot followed by wavelength demultiplexing using ring resonators and final demodulation using the photodetectors.

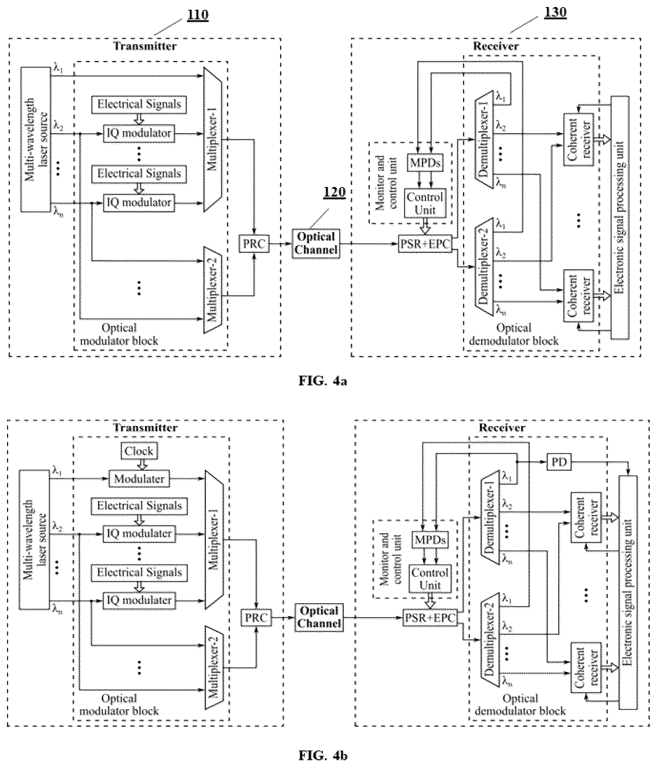

FIG. 3A is a block diagram illustrating the multi-wavelength dual-polarization coherent interconnect with the OP-APD technique according to embodiments as disclosed herein, and FIG. 3B is a block diagram illustrating the multi-wavelength dual-polarization coherent interconnect with the OP-APD-CR technique according to embodiments as disclosed herein.

The FIGS. 3A-3B illustrate two possible embodiments of the proposed system (100) shown in FIG. 1. FIG. 3A and FIG. 3B both illustrate a multi-wavelength dual-polarization coherent interconnect, one with the OP-APD technique and the other with the OP-APD-CR technique, respectively. Similarly, a multi-wavelength dual-polarization coherent interconnect with the OP-CR technique is also possible. As proposed in the system (100), these embodiments can also be divided into three main parts, including a transmitter (110), an optical channel (120), and a receiver (130).

FIG. 3A illustrates an embodiment of the proposed OP-APD technique, which is used in a dual-polarization coherent link. This figure shows only one embodiment of the OP-APD technique-based system. Many other embodiments are also possible. For example, the modulators used in the optical modulator block (112) may be intensity modulators instead of IQ modulators. Also, there may optionally be a modulated signal in one of the polarization channels in wavelength λ1. FIG. 3B illustrates an embodiment of the proposed OP-APD-CR technique, which is used in the dual-polarization coherent link. This figure shows only one embodiment of the OP-APD-CR technique-based system. Many other embodiments are also possible.

In an embodiment, in the transmitter (110), a combination of components is used. The system (100) comprises an MWLS (111), one optical modulator block (112), and one polarization multiplexer (P-Mux) (113) as visually illustrated in FIGS. 3A-3B. The MWLS (111) selected for this purpose emits light across a spectrum of “n” wavelengths (λ₁, λ₂, λ₃, λₙ) , each directed into a dedicated waveguide. Each output of the MWLS (111) is split into two, including one for each polarization channel except the output with wavelength λ₁ designated as the optical pilot. This configuration yields a total of 2n−1 sub-channels, including “n−1” polarization channel pairs corresponding to wavelengths λ₂, λ₃, λₙ, which serve as carriers for optical modulation, while one sub-channel is reserved for the pilot wavelength λ₁. Each of the “n−1” polarization channel pairs comprises two sub-channels of the same wavelength, one for each polarization channel. All sub-channels are modulated independently by input electrical signals using IQ modulators within the optical modulator block (112) before being directed to the WDMs. FIG. 3A illustrates the transmission of the optical pilot without modulation, whereas FIG. 3B illustrates the modulation of the optical pilot with an electrical clock signal for clock recovery at the receiving end, i.e., at the receiver (130). Following modulation, each optical signal within a polarization channel pair associated with a specific wavelength is transmitted to two separate WDMs, each dedicated to a distinct polarization channel. The optical pilot can be directed to the input of any one of the WDMs. The WDMs combine all the input optical signals of different wavelengths into two waveguides, one corresponding to each polarization channel. Finally, the two waveguides from the output of the optical modulator block (112) are multiplexed into one combined optical signal with the P-Mux (113), where each polarization channel is assigned to one of the two principal orthogonal polarization axes. This combined optical signal, consisting of the optical pilot and independent modulated signals, is then transmitted over the optical channel (120).

In an embodiment, the optical channel (120) is used for the transmission of the combined optical signal from the transmitter (110) to the receiver (130). The optical channel (120) can be an optical fiber or some other medium that allows the propagation of light. Free space through which light can propagate can also be considered an optical channel. During transmission through the optical channel (120), the combined optical signal experiences impairments such as time-dependent polarization rotation and polarization mode dispersion in addition to other impairments. Polarization rotation and polarization mode dispersion lead to scrambling of the states of polarization of the optical signal obtained at the input of the receiver (130). This scrambling leads to intermixing of different polarization components at the receiver (130), which makes it difficult to recover the originally transmitted signal. This problem underscores the importance of implementing polarization tracking mechanisms at the receiver (130), which can help in de-scrambling the states of polarization of the received signal and receiving the desired signals as the two orthogonal polarization components in the receiver (130).

In an embodiment, the received signal is directed to the receiver (130) where it undergoes a series of processes. Initially, the signal is split and rotated using a Polarization Splitter and Rotator (PSR). The PSR outputs are then routed to an Electronic Polarization Controller (EPC), which electronically adjusts the polarization of the received optical signal to achieve maximum separation of two polarization channels. The first output from the EPC is sent to the first polarization demultiplexer (131), which separates the WDM signals in the first orthogonal polarization channel. The demultiplexed signal at wavelength λ1 is then split into two by a power splitter. One split output is fed back to an MPD, while the other is directed to a photodetector followed by an electronic signal processing unit (134) to retrieve the clock signal. Simultaneously, the second output from the EPC is sent to the second polarization demultiplexer (131) to segregate the WDM signals in the second orthogonal polarization channel. The demultiplexed signal at wavelength λ1 is fed back to another MPD. The outputs of the MPDs are sent to the monitor and control unit (133), which generates control signals for the EPC based on power minimization and/or maximization technique(s). This ensures the tracking of the original SOP of the pilot signal along with the modulated signals. All demultiplexed signals spanning wavelengths λ2 to λn are directed to the signal input of the coherent receivers. These receivers can be implemented using splitters, combiners, 90-degree phase shifters, and balanced photodetectors as described in an existing mechanism. A secondary multi-wavelength laser source (111) generating light at multiple wavelengths (λ2 to λn) is used as a local oscillator. The outputs of this secondary multi-wavelength laser source (111) are split using the power splitters and fed to the local oscillator inputs of the coherent receivers. The output from the coherent receivers is then transmitted to the electronic signal processing unit (134), which extracts the original information using the recovered clock signal. Clock recovery can be achieved using the OP-APD-CR technique. Alternatively, analog or digital signal processing-based clock recovery techniques can also be utilized.

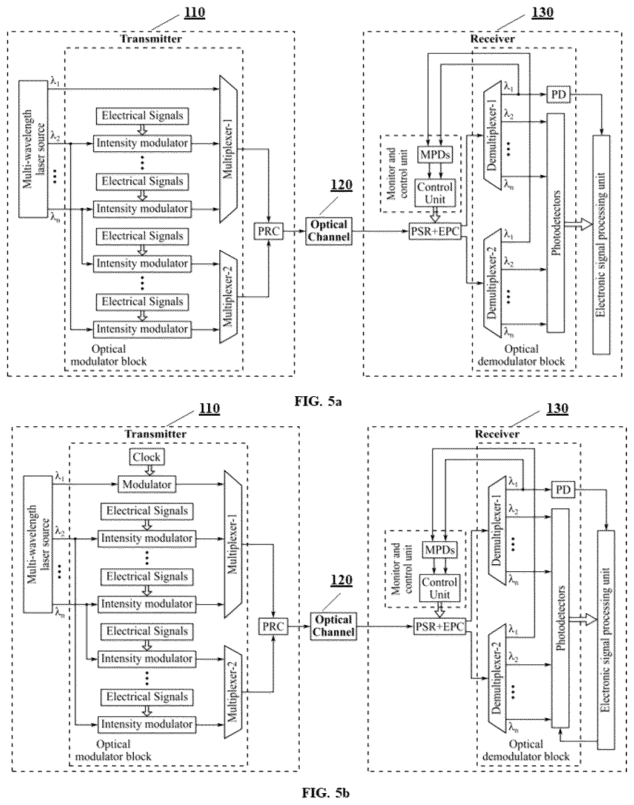

FIG. 4A is a block diagram illustrating a multi-wavelength PMC-SH interconnect with the OP-APD technique according to embodiments as disclosed herein, and FIG. 4B is a block diagram illustrating a multi-wavelength PMC-SH interconnect with the OP-APD-CR technique according to embodiments as disclosed herein.

The FIGS. 4A-4B illustrate two of the possible embodiments of the proposed system (100) depicted in FIG. 1. FIG. 4A and FIG. 4B both depict a multi-wavelength PMC-SH interconnect, one with the OP-APD technique and one with the OP-APD-CR technique, respectively. Similarly, a multi-wavelength PMC-SH interconnect with the OP-CR technique is also possible.

As proposed in the system (100), these embodiments can also be divided into three main parts such as a transmitter (110), an optical channel (120), and a receiver (130). FIG. 4A depicts an embodiment of the proposed OP-APD technique, which is used in a polarization multiplexed carrier-based self-homodyne coherent link. This figure shows only one embodiment of the OP-APD technique-based system. Many other embodiments are also possible. FIG. 4B illustrates an embodiment of the proposed OP-APD-CR technique, which is used in a polarization multiplexed carrier-based self-homodyne coherent link. This figure shows only one embodiment of the OP-APD-CR technique-based system. Many other embodiments are also possible.

In an embodiment, in the transmitter (110), a combination of components is used. The system comprises an MWLS (111), one optical modulator block (112), and one P-Mux (113) as depicted in FIGS. 4A-4B. The MWLS (111) selected for this purpose emits light across a spectrum of “n” wavelengths (λ₁, λ₂, λ₃, λₙ), each directed into a dedicated waveguide. Each output of the MWLS (111) is split into two, one for each polarization channel, except the output with wavelength λ₁ designated as the optical pilot. This configuration yields a total of 2n−1 sub-channels. “n−1” polarization channel pairs correspond to wavelengths λ₂, λ₃, λₙ, which serve as carriers for optical modulation, while one sub-channel is reserved for the pilot wavelength λ₁. Each of the “n−1” polarization channel pairs comprises two sub-channels of the same wavelength, one for each polarization channel. One sub-channel of each pair is modulated independently by input electrical signals using IQ modulators within the optical modulator block (112), while the other one remains unmodulated. Thereafter, both the modulated and unmodulated sub-channels are directed to the WDMs. FIG. 4A illustrates the transmission of the optical pilot without modulation, whereas FIG. 4B illustrates the modulation of the optical pilot with an electrical clock signal for pilot-assisted clock recovery at the receiving end. Following modulation, each optical signal within a polarization channel pair associated with a specific wavelength is transmitted to two separate WDMs, each dedicated to a distinct polarization channel. The optical pilot can be directed to the input of any one of the WDMs. The WDMs combine all the input optical signals of different wavelengths into two waveguides, one corresponding to each polarization channel. Finally, the two waveguides from the output of the optical modulator block (112) are multiplexed into one combined optical signal with the P-Mux (113), where each polarization channel is assigned to one of the two principal orthogonal polarization axes. This combined optical signal, consisting of the optical pilot and independent modulated signals, is then transmitted over the optical channel (120).

In an embodiment, the optical channel (120) is used for the transmission of the combined optical signal from the transmitter (110) to the receiver (130). The optical channel (120) can be an optical fiber or some other medium that allows the propagation of light. Free space through which the light can propagate can also be considered as an optical channel (120). During transmission through the optical channel (120), the combined optical signal experiences impairments such as time-dependent polarization rotation and polarization mode dispersion in addition to other impairments. Polarization rotation and polarization mode dispersion lead to scrambling of the states of polarization of the optical signal obtained at the input of the receiver (130). This scrambling leads to intermixing of different polarization components at the receiver (130), which makes it difficult to recover the originally transmitted signal. This problem underscores the importance of implementing polarization tracking mechanisms at the receiver (130), which can help de-scramble the states of polarization of the received signal and receive the desired signals as the two orthogonal polarization components in the receiver (130).

In an embodiment, the received signal is directed to the receiver (130) where it undergoes a series of processes. Initially, the signal is split and rotated using a PSR. The PSR outputs are then routed to an EPC, which electronically adjusts the polarization of the received optical signal to achieve maximum separation of two polarization channels. The first output from the EPC is sent to the first polarization demultiplexer (131), which separates the WDM signals in the first orthogonal polarization channel. The demultiplexed signal at wavelength λ₁ corresponds to the optical pilot. In FIG. 4A, the optical pilot is directly fed into an MPD. FIG. 4B illustrates the optical pilot being split into two; one of its outputs is fed into an MPD while the other is directed to a photodetector followed by an electronic signal processing unit (134) to retrieve the clock signal. Simultaneously, the second output from the EPC is sent to the second polarization demultiplexer (131) to segregate the WDM signals in the second polarization channel. The demultiplexed signal at wavelength λ₁ (optical pilot) is fed back to another MPD. The outputs of the MPDs are sent to the monitor and control unit (133), which generates control signals for the EPC based on power minimization and/or maximization technique(s). This ensures accurate tracking of the received combined optical signal for effectively separating the optical signals in the two orthogonal polarization channels. All demultiplexed signals are spanning over wavelengths λ₂ to λₙ. Each of these wavelengths comprises one modulated signal and one carrier. The pairs of modulated signals and the carriers of the same wavelengths are directed to the two inputs of the coherent receivers for demodulation. These receivers can be implemented using splitters, combiners, 90-degree phase shifters, and balanced photodetectors as described in an existing mechanism. The output from the coherent receivers is then transmitted to the electronic signal processing unit (134), which extracts the original information using the recovered clock signal. Clock recovery can be achieved using the OP-APD-CR technique. Alternatively, analog or digital signal processing-based clock recovery techniques can also be utilized.

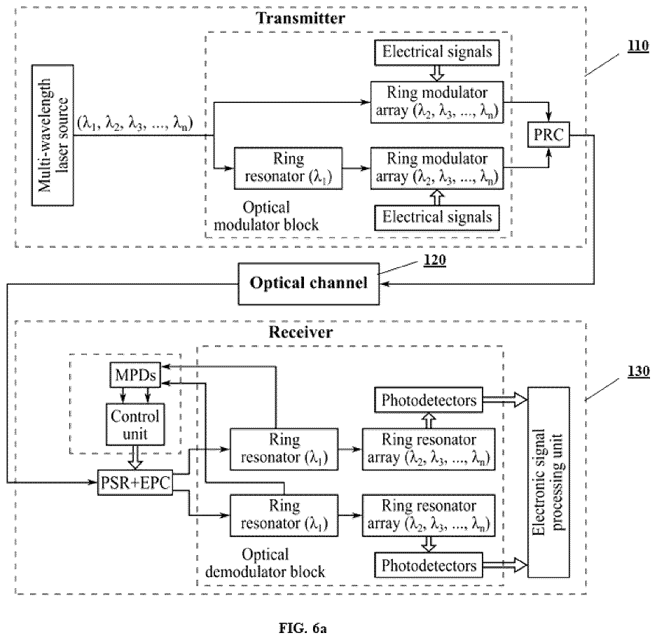

FIG. 5A is a block diagram illustrating the multi-wavelength IM-DD interconnect with the OP-APD technique according to embodiments as disclosed herein, and FIG. 5B is a block diagram illustrating the multi-wavelength IM-DD interconnect with the OP-APD-CR technique according to embodiments as disclosed herein.

The FIG. 5A illustrates an embodiment of the proposed OP-APD technique, which is used in an IM-DD link. This figure shows only one embodiment of the OP-APD technique-based system. Many other embodiments are also possible. The FIG. 5B illustrates an embodiment of the proposed OP-APD-CR technique, which is used in an IM-DD link. This figure shows only one embodiment of the OP-APD-CR technique-based system. Many other embodiments are also possible. The FIGS. 5A-5B illustrate two of the possible embodiments of the proposed system (100) depicted in FIG. 1. The FIG. 5A and FIG. 5B both illustrate a multi-wavelength IM-DD interconnect, one with the OP-APD technique and one with the OP-APD-CR technique, respectively. Similarly, a multi-wavelength IM-DD interconnect with the OP-CR technique is also possible. As proposed in the system (100), these embodiments can also be divided into three main parts, including a transmitter (110), an optical channel (120), and a receiver (130).

In an embodiment, in the transmitter (110), a combination of components is used. The system (100) comprises an MWLS (111), one optical modulator block (112), and one P-Mux (113) as illustrated in FIGS. 5A-5B. The MWLS (111) selected for this purpose emits light across a spectrum of “n” wavelengths (λ₁, λ₂, λ₃, . . . , λₙ) , each directed into a dedicated waveguide. Each output of the MWLS (111) is split into two, including one for each polarization channel except the output with wavelength λ₁ designated as the optical pilot. This configuration yields a total of 2n−1 sub-channels, including “n−1” polarization channel pairs corresponding to wavelengths λ₂, λ₃, . . . , λₙ, which serve as carriers for optical modulation, while one sub-channel is reserved for the pilot wavelength λ₁. Each of the “n−1” polarization channel pairs comprises two sub-channels of the same wavelength, one for each polarization channel. All sub-channels are modulated independently by input electrical signals using intensity modulators within the optical modulator block (112) before getting directed to the wavelength division multiplexers (WDMs). Notably, the FIG. 5A illustrates the transmission of the optical pilot without modulation, whereas the FIG. 5B illustrates the modulation of the optical pilot with an electrical clock signal for pilot-assisted clock recovery at the receiving end. Following modulation, each optical signal within a polarization channel pair associated with a specific wavelength is transmitted to two separate WDMs, each dedicated to a distinct polarization channel. The optical pilot can be directed to the input of any one of the WDMs. The WDMs combine all the input optical signals of different wavelengths into two waveguides, one corresponding to each polarization channel. Finally, the two waveguides from the output of the optical modulator block are multiplexed into one combined optical signal with the P-Mux, where each polarization channel is assigned to one of the two principal orthogonal polarization axes. This combined optical signal, consisting of the optical pilot and independent modulated signals, is then transmitted over the optical channel (120).

In an embodiment, the optical channel (120) is used for the transmission of the combined optical signal from the transmitter (110) to the receiver (130). The optical channel (120) can be an optical fiber or some other medium that allows the propagation of light. Free space through which light can propagate can also be considered as an optical channel (120). During transmission through the optical channel (120), the combined optical signal experiences impairments such as time-dependent polarization rotation and polarization mode dispersion in addition to other impairments. Polarization rotation and polarization mode dispersion lead to scrambling of the states of polarization of the optical signal obtained at the input of the receiver (130). This scrambling leads to intermixing of different polarization components at the receiver (130), which makes it difficult to recover the originally transmitted signal. This problem underscores the importance of implementing polarization tracking mechanisms at the receiver (130), which can help de-scramble the states of polarization of the received signal and receive the desired signals as the two orthogonal polarization components in the receiver (130).

In an embodiment, the received signal is directed to the receiver (130) where it undergoes a series of processes. Initially, the signal is split and rotated using a PSR. The PSR outputs are then routed to an EPC, which electronically adjusts the polarization of the received optical signal to achieve maximum separation of two polarization channels. The first output from the EPC is sent to the first polarization demultiplexer (131), which separates the Wavelength Division Multiplexed (WDM) signals in the first orthogonal polarization channel. The demultiplexed signal at wavelength λ₁ corresponds to the optical pilot. In FIG. 4A, the optical pilot is directly fed into an MPD. The FIG. 5B illustrates the optical pilot being split into two, including one of its outputs being fed into an MPD while the other is directed to a photodetector followed by an electronic signal processing unit (134) to retrieve the clock signal. Simultaneously, the second output from the EPC is sent to the second polarization demultiplexer (131) to segregate the WDM signals in the second orthogonal polarization channel. The demultiplexed signal at wavelength λ₁ (optical pilot) is fed back to another MPD. The outputs of the MPDs are sent to the control unit, which generates control signals for the EPC based on power minimization and/or maximization technique(s). This ensures accurate tracking of the received combined optical signal for effectively separating the optical signals in the two orthogonal polarization channels. All demultiplexed signals spanning wavelengths λ₂ to λₙ are directed to the signal input of the photodetectors, which convert the optical signals into electrical signals. These electrical signal outputs from the photodetectors are then transmitted to the electronic signal processing unit (134), which extracts the original information using the recovered clock signal. Clock recovery can be achieved using the OP-APD-CR technique. Alternatively, analog or digital signal processing-based clock recovery techniques can also be utilized.

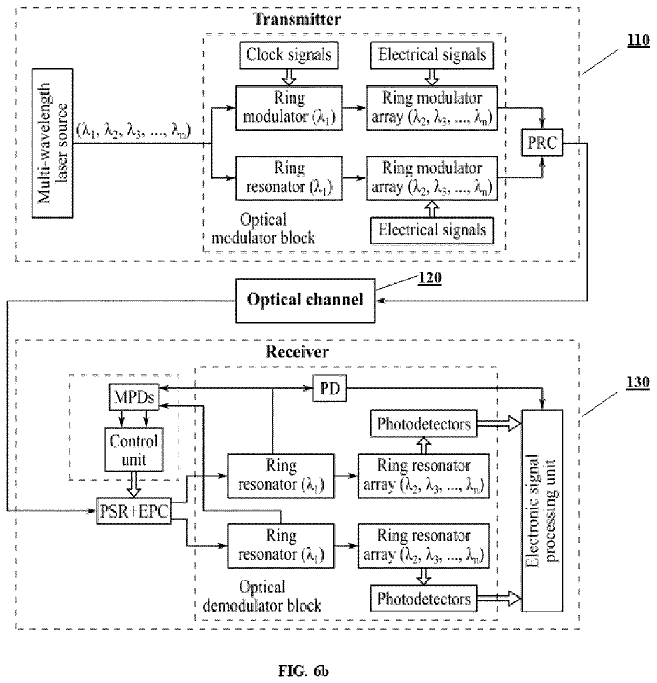

FIG. 6A is a block diagram illustrating the multi-wavelength co-packaged optics-based IM-DD interconnect with the OP-APD technique according to embodiments as disclosed herein, and FIG. 6B is a block diagram illustrating the multi-wavelength co-packaged optics-based IM-DD interconnect with the OP-APD-CR technique according to embodiments as disclosed herein.

The FIGS. 6A-6B illustrate two of the possible embodiments of the proposed generic system (100) shown in FIG. 1. The FIG. 6A and FIG. 6B both illustrate a multi-wavelength co-packaged optics-based IM-DD interconnect, one with the OP-APD technique and one with the OP-APD-CR technique, respectively. Similarly, a multi-wavelength IM-DD interconnect with the OP-CR technique is also possible. As proposed in the generic system (100), these embodiments can also be divided into three main parts, including a transmitter (110), an optical channel (120), and a receiver (130).

The FIG. 6A illustrates an embodiment of the proposed OP-APD technique, which is used in a co-packaged optics-based IM-DD link. This figure shows only one embodiment of the OP-APD technique-based system. Many other embodiments are also possible. The FIG. 6B illustrates an embodiment of the proposed OP-APD-CR technique, which is used in a co-packaged optics-based IM-DD link. This figure shows only one embodiment of the OP-APD-CR technique-based system. Many other embodiments are also possible.

In an embodiment, in the transmitter (110), a combination of components is used. The system (100) comprises an MWLS (111), one optical modulator block (112), and one P-Mux (113) as illustrated in FIGS. 6A-6B. The MWLS (111) selected for this purpose emits light across a spectrum of “n” wavelengths (λ₁, λ₂, λ₃, . . . λₙ) , all of them directed through a single waveguide. The output of the MWLS (111) is split into two, one for each polarization channel. This results in two polarization channels, each channel containing wavelengths spanning λ₁, λ₂, λ₃, . . . λₙ, where the wavelength λ₁ corresponds to the optical pilot and the wavelengths λ₂, λ₃, . . . λₙ serve as carriers for optical modulation. To make sure the optical pilot is only in one of the orthogonal polarization channels, the λ₁ component is filtered out in one of the orthogonal polarization channels using a ring resonator within the optical modulator block (112). Each of the two polarization channels thus obtained is modulated by input electrical signals using ring modulator arrays within the optical modulator block (112). The FIG. 6A illustrates the transmission of the optical pilot in one of the orthogonal polarization channels without any modulation. The FIG. 6B illustrates the modulation of the optical pilot with an electrical clock signal (in one of the orthogonal polarization channels) using a ring modulator for pilot-assisted clock recovery. Finally, the two waveguides from the output of the optical modulator block (112) are multiplexed into one combined optical signal with a PRC, where each polarization channel is assigned to one of the two principal orthogonal polarizations. This combined optical signal, consisting of the optical pilot and independent modulated signal, is then transmitted over the optical channel (120).

In an embodiment, the optical channel (120) is used for the transmission of the combined optical signal from the transmitter (110) to the receiver (130). The optical channel (120) can be an optical fiber or some other medium that allows the propagation of light. Free space through which light can propagate can also be considered as an optical channel (120). During transmission through the optical channel (120), the combined optical signal experiences impairments such as time-dependent polarization rotation and polarization mode dispersion in addition to other impairments. Polarization rotation and polarization mode dispersion lead to scrambling of the states of polarization of the optical signal obtained at the input of the receiver (130). This scrambling leads to intermixing of different polarization components at the receiver (130), which makes it difficult to recover the originally transmitted signal. This problem underscores the importance of implementing polarization tracking mechanisms at the receiver (130), which can help in de-scrambling the states of polarization of the received signal and receiving the desired signals as the two orthogonal polarization components in the receiver (130).

In an embodiment, the received signal is directed to the receiver (130) where it undergoes a series of processes. Initially, the signal is split and rotated using a PSR. The PSR outputs are then routed to an EPC, which electronically adjusts the polarization of the received optical signal to achieve maximum separation of two polarization channels. The first output from the EPC is sent to the first polarization demultiplexer (131) (ring resonator array), which separates the WDM signals in the first orthogonal polarization channel. The demultiplexed signal at wavelength λ₁ corresponds to the optical pilot. In FIG. 6A, the optical pilot is directly fed into an MPD. The FIG. 6B illustrates the optical pilot being split into two, including one of its outputs being fed into the MPD while the other is directed to a photodetector followed by an electronic signal processing unit (134) to retrieve the clock signal. Simultaneously, the second output from the EPC is sent to the second polarization demultiplexer (131) (ring resonator array) to segregate WDM signals in the second orthogonal polarization channel. The demultiplexed signal at wavelength λ₁ (optical pilot) is fed back to another MPD. The outputs of the MPDs are sent to the monitor and control unit (133), which generates control signals for the EPC based on power minimization and/or maximization technique(s). This ensures accurate tracking of the received combined optical signal for effectively separating the optical signals in the two orthogonal polarization channels. All demultiplexed signals spanning wavelengths λ₂ to λₙ are directed to the signal input of the photodetectors, which convert the optical signals into electrical signals. These electrical signal outputs from the photodetectors are then transmitted to the electronic signal processing unit (134), which extracts the original information using the recovered clock signal. Clock recovery can be achieved using the OP-APD-CR technique. Alternatively, analog or digital signal processing-based clock recovery techniques can also be utilized.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. An optical interconnect system (100) with optical pilot assisted reception at a receiver (130), comprising:
at least one transmitter (110) comprising:
at least one multi-wavelength laser source (111) configured to emit light with a plurality of wavelengths comprising at least one optical pilot and a plurality of wavelength carriers;
at least one optical modulator block (112) connected to the multi-wavelength laser source (111), wherein the optical modulator block (112) configured to split the received carriers into two polarization channels corresponding to light in the two orthogonal polarization components, and wherein at least one of the carrier components in each of the channels is modulated independently with the input electrical signals using electro-optic modulators;
at least one polarization multiplexer (P-Mux) (113) connected to the optical modulator block (112), wherein the P-Mux (113) combines at least one independent modulated signal and at least one optical pilot at different wavelengths from the two polarization channels into a polarization-multiplexed signal; and
at least one optical channel (120) connecting the transmitter (110) to the receiver (130), wherein the optical channel (120) transmits the polarization-multiplexed signal from the transmitter (110) to the receiver (130).

2. The optical interconnect system as claimed in claim 1, comprising:
at least one receiver (130) connected to the optical channel (120) comprising:
i. at least one polarization demultiplexer (P-Demux) (131) connected to the optical channel (120), wherein the P-Demux (131) adjusts the polarization of the polarization-multiplexed signal and splits a modulated signal in the first polarization channel, and an optical pilot in the second polarization channel along with optionally other modulated signals or unmodulated carrier,
ii. at least one optical demodulator block (132) connected to the P-Demux (131) wherein the optical demodulator block (132) demultiplexes the first input polarization channel to a subset of wavelength channels using a wavelength demultiplexer, and demultiplexes the second input polarization channel to a subset of wavelength channels using a wavelength demultiplexer,
iii. at least one monitor and control unit (133) connected to the optical demodulator block (132) and the P-Demux (131), wherein the at least one of the polarization components of the optical pilot wavelength channel is tapped into the monitor and control unit (133) and generates control signals to the P-Demux (131) using the monitor and control unit (133), and
iv. at least one electronic signal processing unit (134) connected to the optical demodulator block (132), wherein the electronic signal processing unit (134) receives electrical signals after demodulating at least one of the modulated optical signals in one of the wavelength channels, wherein the received electrical signals are used for processing of the electrical signals.

3. The optical interconnect system (100) as claimed in claim 1, wherein the multiwavelength laser source (111) is configured to emit light with a plurality of wavelengths in different optical waveguides.

4. The optical interconnect system (100) as claimed in claim 1, wherein the multiwavelength laser source (111) is configured to emit light with a plurality of wavelengths in a single optical waveguide.

5. The optical interconnect system (100) as claimed in claim 1, wherein at least one of the carriers or the optical pilots is modulated with a clock at the transmitter (110) to aid in clock recovery at the receiver (130) and wherein the electronic signal processing unit (134) at the receiver (130) is configured to recover clock from at least one of the clock modulated carriers or the clock modulated optical pilots.

6. The optical interconnect system (100) as claimed in claim 1, wherein the optical modulator block (112) comprises at least one of Ring modulators and electro-optic modulators, wherein the ring modulators are used when all the wavelengths are present in the single optical waveguide to modulate different wavelength components by different electrical signals and wherein the electro-optic modulators are used when different wavelengths are present in different or separate optical waveguides.

7. The optical interconnect system (100) as claimed in claim 1, wherein the polarization corrected signal at the P-Demux (131) is separated into two individual waveguides, each corresponding to one polarization channel.

8. The optical interconnect system (100) as claimed in claim 1, wherein the polarization demultiplexer (131) comprises at least one combination of a polarization splitter rotator (PSR) and a polarization controller (PC) or a PC and a polarization beam splitter (PBS).

9. The optical interconnect system (100) as claimed in claim 1, wherein the optical demodulator block (132) demultiplexes the first input polarization channel to a subset of wavelength channels using a ring resonator array and demultiplexes the second input polarization channel to a subset of wavelength channels using a ring resonator array.

10. The optical interconnect system (100) as claimed in claim 1, wherein the control signals given by the monitor and control unit (133) to the polarization demultiplexer (131) are adjusted to maximize the average optical power of the optical pilot in one of the polarization channels or minimize it in the other polarization channel or maximize the difference in average optical powers between the two orthogonal polarization channels using the monitor and control unit (133) for separation of independent modulated optical signals in the two orthogonal polarizations.

11. The optical interconnect system (100) as claimed in claim 1, wherein the control signals given by the monitor and control unit (133) to the polarization demultiplexer (131) are adjusted to maximize the average optical power of all the optical signals in one of the polarization channels or minimize the average optical power of all the optical signals in the other polarization channel or maximize the difference in average optical powers between the two orthogonal polarization channels using monitor and control unit (133) for separation of the modulated optical signals in the two orthogonal polarizations.

12. The optical interconnect system (100) as claimed in claim 1, wherein the wavelength carriers are In-phase and Quadrature-phase (IQ) modulated to get independent coherent modulated signals for the two orthogonal polarizations of each wavelength channel, combined with the optical pilot, polarization multiplexed and transmitted over the optical channel (120), and corresponding Local Oscillator (LO) signals are generated at the receiver (130) using a multi-wavelength laser source (111) for a coherent demodulation of the coherent modulated signals after polarization demultiplexing.

13. The optical interconnect system (100) as claimed in claim 1, wherein the wavelength carriers are IQ modulated to get coherent modulated signals, corresponding carriers are transmitted in the orthogonal polarization that are used as LO for coherent demodulation of the coherent modulated signal after polarization demultiplexing.

14. The optical interconnect system (100) as claimed in claim 1, wherein the wavelength carriers are intensity modulated at the transmitter (110) to obtain intensity modulated signals, combined with an optical pilot present as an independent wavelength in one of the polarization channels polarization multiplexed, and then transmitted and polarization demultiplexed at the receiver (130) assisted by the optical pilot, before being demodulated using photodetectors.

15. The optical interconnect system (100) as claimed in claim 14, wherein the wavelength carriers are intensity modulated at the transmitter (110) to obtain intensity modulated signals using ring modulator array, combined with an optical pilot present as an independent wavelength channel that is present in one of the polarization channels and suppressed in the other polarization channel, polarization multiplexed, transmitted through the optical channel (120), after which they are polarization demultiplexed at the receiver (130) assisted by the optical pilot, followed by wavelength demultiplexing using ring resonators, and final demodulation using photodetectors.

16. A method for optical pilot assisted reception at a receiver (130), comprising:
emitting, by an optical interconnect system (100), light with a plurality of wavelengths comprising at least one optical pilot and a plurality of wavelength carriers;
splitting, by the optical interconnect system (100), the received carriers into two polarization channels corresponding to light in the two orthogonal polarization components, and wherein at least one of the carrier components in each of the channels is modulated independently with the input electrical signals using electro-optic modulators;
combining, by the optical interconnect system (100), at least one independent modulated signals and at least one optical pilot at different wavelengths from the two polarization channels into a polarization-multiplexed signal; and
transmitting, by the optical interconnect system (100), the polarization-multiplexed signal from the transmitter (110) to the receiver (130).

17. The method as claimed in claim 16, comprising:
adjusting, by the optical interconnect system (100), the polarization of the polarization-multiplexed signal and splitting a modulated signal in the first polarization channel, and an optical pilot in the second polarization channel along with optionally other modulated signals or unmodulated carrier;
demultiplexing, by the optical interconnect system (100), the first input polarization channel to a subset of wavelength channels using a wavelength demultiplexer, and demultiplexing the second input polarization channel to a subset of wavelength channels using a wavelength demultiplexer;
tapping, by the optical interconnect system (100), at least one of the polarization components of the optical pilot wavelength channel into the monitor and control unit (133) and generating control signals to the P-Demux using the monitor and control unit (133);
receiving, by the optical interconnect system (100), electrical signals after demodulating at least one of the modulated optical signals in one of the wavelength channels, wherein the received electrical signals are used for processing of the electrical signals.

18. The method as claimed in claim 16, wherein a multiwavelength laser source (111) emits light with a plurality of wavelengths in different optical waveguides.

19. The method as claimed in claim 16, wherein the multiwavelength laser source (111) emits light with a plurality of wavelengths in a single optical waveguide.

20. The method as claimed in claim 16, wherein at least one of the carriers or the optical pilots is modulated with a clock at the transmitter (110) to aid in clock recovery at the receiver (130) and wherein the electronic signal processing unit (134) at the receiver (130) is configured to recover clock from at least one of the clock modulated carriers or the clock modulated optical pilots.

21. The method as claimed in claim 16, wherein the optical modulator block (112) comprises at least one of Ring modulators and electro-optic modulators, wherein the ring modulators are used when all the wavelengths are present in the single optical waveguide to modulate different wavelength components by different electrical signals and wherein the electro-optic modulators are used when different wavelengths are present in different or separate optical waveguides.

22. The method as claimed in claim 16, wherein the polarization corrected signal at the P-Demux (131) is separated into two individual waveguides, each corresponding to one polarization channel.

23. The method as claimed in claim 16, wherein the polarization demultiplexer (131) comprises at least one combination of a polarization splitter rotator (PSR) and a polarization controller (PC) or the PC and a polarization beam splitter (PBS).

24. The method as claimed in claim 16, wherein the optical demodulator block (132) demultiplexes the first input polarization channel to a subset of wavelength channels using a ring resonator array and demultiplexes the second input polarization channel to a subset of wavelength channels using a ring resonator array.

25. The method as claimed in claim 16, wherein the control signals given by the monitor and control unit (133) to the polarization demultiplexer (131) are adjusted to maximize the average optical power of the optical pilot in one of the polarization channels or minimize it in the other polarization channel or maximize the difference in average optical powers between the two orthogonal polarization channels using the monitor and control unit (133) for separation of independent modulated optical signals in the two orthogonal polarizations.

26. The method as claimed in claim 16, wherein the control signals given by the monitor and control unit (133) to the polarization demultiplexer (131) are adjusted to maximize the average optical power of all the optical signals in one of the polarization channels or minimize the average optical power of all the optical signals in the other polarization channel or maximize the difference in average optical powers between the two orthogonal polarization channels using the monitor and control unit (133) for separation of the modulated optical signals in the two orthogonal polarizations.

27. The method as claimed in claim 16, wherein the wavelength carriers are In-phase and Quadrature-phase (IQ) modulated to get independent coherent modulated signals for the two orthogonal polarizations of each wavelength channel, combined with the optical pilot, polarization multiplexed and transmitted over the optical channel (120), and corresponding Local Oscillator (LO) signals are generated at the receiver (130) using a multi-wavelength laser source (111) for a coherent demodulation of the coherent modulated signals after polarization demultiplexing.

28. The method as claimed in claim 16, wherein the wavelength carriers are IQ modulated to get coherent modulated signals, corresponding carriers are transmitted in the orthogonal polarization that are used as LO for coherent demodulation of the coherent modulated signal after polarization demultiplexing.

29. The method as claimed in claim 16, wherein the wavelength carriers are intensity modulated at the transmitter (110) to obtain intensity modulated signals, combined with an optical pilot present as an independent wavelength in one of the polarization channels, polarization multiplexed, and then transmitted and polarization demultiplexed at the receiver (130) assisted by the optical pilot, before being demodulated using photodetectors.

30. The method as claimed in claim 29, wherein the wavelength carriers are intensity modulated at the transmitter (110) to obtain intensity modulated signals using ring modulator array, combined with an optical pilot present as an independent wavelength channel that is present in one of the polarization channels and suppressed in the other polarization channel, polarization multiplexed, transmitted through the optical channel, after which they are polarization demultiplexed at the receiver (130) assisted by the optical pilot, followed by wavelength demultiplexing using ring resonators, and final demodulation using photodetectors.
